(19) United States
(12) Patent Application Publication
(10) Pub. No.: US 2001/0015993 A1
(43) Pub. Date: Aug. 23, 2001

(54) Composite laser crystal and solid-state laser device using the same

(76) Inventors: Satoshi Wada, Saitama (JP); Hideo Tashiro, Saitama (JP)

Correspondence Address: LOWE HAUPTMAN GILMAN & BERNER, LLP, 1700 Diagonal Road, Suite 310, Alexandria, VA, 22314, US

(21) Appl. No.: 09/748,151

(22) Filed: Dec. 27, 2000

(30) Foreign Application Priority Data
Dec. 28, 1999 (JP) 373172/1999

(51) Int. Cl. H01S 3/08

(52) U.S. Cl. 372/106

(57) ABSTRACT

The present invention provides a solid-state laser device in which an alignment operation for arranging optical elements for compensating thermal birefringence is easy, and which is mechanically highly stable by being tolerant of oscillation.

A 90° polarization rotator 12 is arranged between and integrated with two solid-state laser media 11 and 13 via diffusion bonding to form a composite laser crystal 10. The composite laser crystal 10 is arranged between constituents 31 and 32 of an optical resonator to form a solid-state laser device.

### FIELD OF THE INVENTION

The present invention relates to a solid-state laser device. More particularly, the present invention relates to a high-power laser device and a composite laser crystal incorporated by the device.

### BACKGROUND OF THE INVENTION

Laser devices are broadly employed in various fields such as spectroscopy, measurement, fabrication, optical communication, clinical medicine and energy engineering. Although a laser medium can be any of gas, liquid or solid, use of a solid-state medium has become major for its handling convenience. Furthermore, in order to generate pumping light for exciting the laser medium, solid-state light sources such as laser diodes (LD) are replacing discharge tubes such as conventional flash lamps/flashtubes. Thus, laser devices having totally solid-state elements are now undergoing development.

A solid-state YAG laser for generating high-power laser light is used as a light source of a laser beam machine, which may perform fabrication such as drilling, welding, cutting and trimming on a work piece such as a metal, ceramic, wood, and a gem. Production of a high-power LD excitation YAG laser is associated with a problem of thermal birefringence generation. Thermal birefringence is a phenomenon which is caused when crystal rods are subjected to heat stress and which results in difference of the refractive indices of light between the radius vector and the vector perpendicular thereto. When such thermal birefringence occurs, a linearly polarized beam from a laser resonator may greatly be distorted depending on the polarization.

In order to compensate such thermal birefringence, two YAG laser crystals are arranged in tandem, and a 90° polarization rotator (half-wave plate) that rotates a plane of polarization by 90° is arranged between the two YAG laser crystals. Thermal birefringence results in two mutually perpendicular components having different refractive indices. By inserting the 90° polarization rotator between the two YAG laser crystal rods, the polarization direction of light propagating through the resonator in one way alters by 90° in front and back of the 90° polarization rotator. Accordingly, polarization components that differ for respective rods can be amplified in both directions. As a result, a biased amplification can be cancelled out, thereby preventing a thermal birefringence effect.

According to the above-described conventional method for compensating thermal birefringence, three optical elements (i.e., two YAG laser crystals and a 90° polarization rotator) need to accurately be aligned on an optical axis of a laser resonator. This alignment takes time for adjustment and the resulting laser device is poorly tolerant of oscillation.

The present invention solves such prior art problems, and has an objective of providing a solid-state laser device in which an alignment operation for arranging optical elements for compensating for thermal birefringence is easy, and which is mechanically highly stable by being tolerant of oscillation.

As a method for simplifying alignment of the three optical elements arranged in the laser resonator, the three optical elements are fixed on a single member in advance as a single unit which is then arranged in the laser resonator, thereby simplifying the alignment operation. This method, however, is unpractical since arranging three optical elements on a single member requires equal amount of labor to that for directly setting the optical elements in the laser resonator.

### SUMMARY OF THE INVENTION

According to the present invention, the above-described objective is achieved by developing a composite laser crystal in which three optical elements (i.e., two YAG laser crystals and a 90° polarization rotator) necessary for compensating for thermal birefringence are formed into a single rod as the composite laser crystal to be arranged in a laser resonator. The two YAG laser crystals and a single half-wave plate (90° polarization rotator) are integrated as a single rod via optical contact, more preferably via diffusion bonding.

In a composite laser crystal of the present invention, a half-wave plate or a 90° polarization rotator is sandwiched between and integrated with two solid-state laser media. The 90° polarization rotator is an optical element which rotates any polarized light by 90°. On the other hand, a half-wave plate rotates specific linearly polarized light by 90° with respect to a plane of polarization. Preferably, the half-wave plate is integrated with the adjacent solid-state laser media via diffusion bonding.

A method for producing a composite laser crystal according to the present invention comprises the steps of: polishing end faces of a pair of Nd:YAG crystals and end faces of the quartz half-wave plate to obtain flat faces with a surface precision of λ/10 or less; arranging the half-wave plate between the pair of Nd:YAG crystals such that the flattened end faces of the crystals make contact with each other, and subjecting the resultant to pressure bonding under a pressure of 1 kg/cm² or higher; heating the crystals subjected to the pressure bonding at 400° C. or higher; and cutting out from the integrated rod obtained by the above steps, a laser crystal of a desirable shape. The surface precision is a value defined by twice the maximum deviation between an ideal reference surface and a polished surface as examined surface, and is represented with respect to HeNe laser wavelength (λ=632.8 nm). Accordingly, λ/10 is about 63 nm.

In order to bond an Nd:YAG crystal and a quartz via diffusion bonding, the surface precision of the faces to be subjected to diffusion bonding need to be λ/10 (i.e., 63 nm) or less. When the surface precision is rougher than this value, bonding does not take place. After passivation of the surface of crystal with acid, diffusion bonding requires heating at a temperature of 400° C. or higher for a predetermined time under a pressure of 1 kg/cm² or higher. When the pressure is lower than 1 kg/cm², or the temperature is lower than 400° C., bonding with sufficient strength may not be achieved.

A solid-state laser device of the invention comprises an optical resonator, a pair of solid-state laser media arranged in the optical resonator, a polarization rotator arranged between the pair of solid-state laser media for rotating a plane of polarization by 90°, and a light source for exciting the laser media, wherein the pair of solid-state laser media and the polarization rotator are integrated by bonding the adjacent end faces thereof. The adjacent end faces are integrated via diffusion bonding.

By using the composite laser crystal of the invention, effect of thermal birefringence can be canceled out. Moreover, a laser device incorporating the composite laser crystal of the invention allows easy adjustment since there is no need of aligning individual optical elements in the laser resonator. As a result, the cost of production can be reduced and mechanical stability can be enhanced for being tolerant of oscillation.

### BRIEF DESCRIPTION OF THE DRAWINGS

FIG. 1 is a schematic view showing an exemplary composite laser crystal of the invention;

FIGS. 2A to 2C are views for illustrating an exemplary method for producing a composite laser crystal; and

FIG. 3 is a schematic view of a solid-state laser device of the invention which incorporates composite laser crystals.

### DESCRIPTION OF THE PREFERRED EMBODIMENTS

Hereinafter, the present invention will be described with reference to the accompanying drawings.

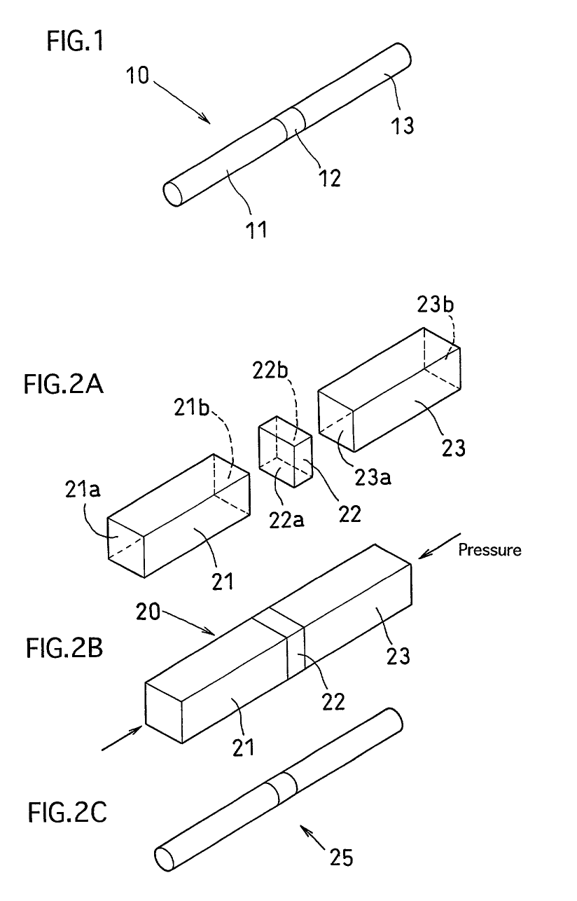

FIG. 1 is a schematic view showing an exemplary composite laser crystal 10 of the invention. The composite laser crystal 10 is provided with two Nd:YAG crystals 11 and 13, and a quartz (crystal) plate (90° polarization rotator) 12 sandwiched therebetween. The adjacent end faces of the Nd:YAG crystal 11 and the quartz plate 12, and the adjacent end faces of the quartz plate 12 and the Nd:YAG crystal 13 are strongly bonded via diffusion bonding. As to the sizes, for example, when this composite laser crystal is to be incorporated by a laser resonator, as a laser medium for canceling out the effect of thermal birefringence to obtain a laser device for oscillating laser light at a wavelength of 1064 nm, the total length and the diameter of the composite laser crystal 10 are about 100 mm and about 4 mm, respectively, and the thickness of the quartz plate 12 used as the 90° polarization rotator is 6 mm.

FIGS. 2A to 2C are views for illustrating an example of a method for producing the composite laser crystal shown in FIG. 1. As shown in FIG. 2A, Nd:YAG crystals 21 and 23 and a quartz 22 are cut out. End faces 21a, 21b; 22a, 22b; and 23a, 23b of the crystals are optically polished. Specifically, the end face 21b of the Nd:YAG crystal 21, the end faces 22a and 22b of the quartz plate 22, and the end face 23a of the Nd:YAG crystal 23 are polished to obtain flat surfaces with a surface precision of λ/10 (about 63 nm) or less.

Then, as shown in FIG. 2B, the end face 21b of the Nd:YAG crystal 21 is made to contact with the end face 22a of the quartz plate 22, and the end face 23a of the Nd:YAG crystal 23 is made to contact with the end face 22b of the quartz plate 22, thereby assembling a rod 20. While applying a pressure of 1 kg/cm² or higher to both ends of the rod 20, the rod 20 is heated at 500° C. After 5 hours, the Nd:YAG crystals 21 and 23 are strongly bonded to the quartz plate 22 at their end faces via diffusion bonding. Diffusion bonding allows optical bonding and mechanical integration, and is advantageous in that no damage is caused at the bonding faces since it does not require adhesion for bonding.

Finally, as shown in FIG. 2C, the rod 20 integrated via diffusion bonding is fabricated into a desirable shape to obtain a composite laser crystal 25. The fabrication is performed by cutting out a cylindrical composite laser crystal 25 from the rod 20 with a core-drill, and then optical polishing both end faces. The composite laser crystal 25 is also subjected to non-reflective coating. Multiple composite laser crystals 25 may be cut out from the rod 20.

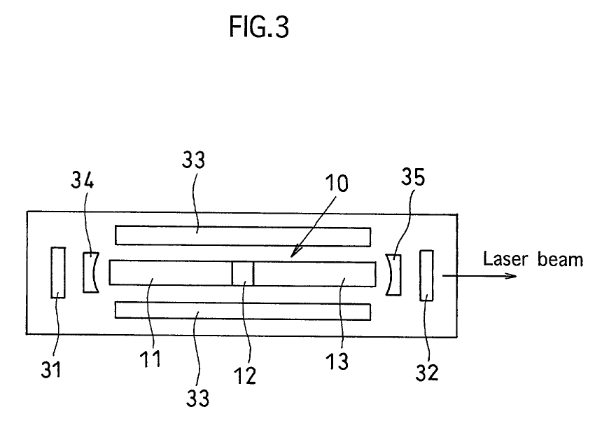

FIG. 3 is a schematic view showing a solid-state laser device of the invention incorporating the composite laser crystal.

The solid-state laser device is provided with a total reflection mirror 31 and a partial reflection mirror 32 with a transmittance of about 70% as constituents of an optical resonator, the composite laser crystal 10 shown in FIG. 1 arranged therebetween, and a high-power LD laser 33 (wavelength: 808 nm) for generating pumping light surrounding the rod 10. Lenses 34 and 35 are arranged between the composite laser crystal 10 and the total reflection mirror 31 and between the composite laser crystal 10 and the partial reflection mirror 32, respectively. Since the composite laser crystal 10 is made of an integrated body of two Nd:YAG crystals 11 and 13 and the quartz plate (90° polarization rotator) 12, there is no requirement of individual alignments of the three optical elements 11, 12 and 13 as in a prior art device. Accordingly, it is very easy to assemble a solid-state laser device. Furthermore, since the three optical elements 11, 12 and 13 are integrated as the composite laser crystal 10, the alignment relationship between the three optical elements 11, 12 and 13 does not change even when the device is subjected to oscillation. Therefore, the output characteristics of the solid-state laser device are not fluctuated by oscillation, maintaining extremely high stability.

Although a quartz plate is used as the 90° polarization rotator in the above-described embodiment, a half-wave plate may be used instead. Although diffusion bonding is employed for bonding the three optical elements to obtain the composite laser crystal in the above-described embodiment, an optical contact may be employed instead. Specifically, the bonding faces of the two rods previously cut out in desirable shapes and the 90° polarization rotator are polished to obtain a surface precision of λ/20 (about 30 nm); the three optical elements are assembled into a single rod by making the bonding faces thereof in contact; and a pressure of about 1 kg/cm² is applied to both ends of the rod, thereby bonding the three optical elements. Bonding by optical contact is easier than diffusion bonding. However, it requires a guide or the like due to its weak adhesive strength.

The solid-state laser device of the invention may be used as a light source of a laser beam machine which may perform fabrication such as drilling, welding, cutting and trimming on a work piece such as a metal, ceramic, wood, and a gem, or as a light source of a marking device. Alternatively, by converting the oscillation wavelength into a shorter wavelength by using non-linear optical elements, the solid-state laser device of the invention may be used as a light source of an exposure device or the like used for pattern exposure during a process of fabricating a semiconductor.

According to the present invention, a high-power solid-state laser can be obtained with easy alignment, which has enhanced mechanical stability and which does not cause thermal birefringent effect.

What is claimed is:

1. A composite laser crystal, wherein a half-wave plate or a 90° polarization rotator is sandwiched between and integrated with two solid-state laser media.

2. A composite laser crystal according to claim 1, wherein the half-wave plate is integrated with the adjacent solid-state laser media via diffusion bonding.

3. A method for producing a composite laser crystal comprising the steps of:
polishing end faces of a pair of Nd:YAG crystals and end faces of the quartz half-wave plate to obtain flat faces with a surface precision of λ/10 or less;
arranging the half-wave plate between the pair of Nd:YAG crystals such that the flattened end faces of the crystals make contact with each other, and subjecting the resultant to pressure bonding under a pressure of 1 kg/cm² or higher;
heating the crystals subjected to the pressure bonding at 400° C. or higher; and
cutting out from the integrated rod obtained by the above steps, a laser crystal of a desirable shape.

4. A solid-state laser device comprising an optical resonator, a pair of solid-state laser media arranged in the optical resonator, a polarization rotator arranged between the pair of solid-state laser media for rotating a plane of polarization by 90°, and a light source for exciting the laser media, wherein the pair of solid-state laser media and the polarization rotator are integrated by bonding the adjacent end faces thereof.

5. A solid-state laser device according to claim 4, wherein the adjacent end faces are integrated via diffusion bonding.
